(19) United States
(12) Patent Application Publication
(10) Pub. No.: US 2026/0116042 A1
(43) Pub. Date: Apr. 30, 2026

(54) MOLDED BODY HAVING HEAT CONTROL CAPABILITY AND METHOD FOR PRODUCING THE SAME

(71) Applicant: SEOYON E-HWA CO., LTD., Anyang (KR)

(72) Inventors: Hyun Jun PARK, Anyang (KR); Dong Young KIM, Anyang (KR); Chan UK HA, Anyang (KR)

(21) Appl. No.: 19/362,376

(22) Filed: Oct. 18, 2025

(30) Foreign Application Priority Data
Oct. 29, 2024 (KR) 10-2024-0149800

(51) Int. Cl. B32B 7/027; B29C 45/16; B29K 105/16; B32B 27/08; B32B 27/20

(52) U.S. Cl. CPC B32B 7/027; B32B 27/08; B32B 27/20; B29C 45/164; B29K 2105/16; B29K 2995/0012; B32B 2250/03; B32B 2250/40

(57) ABSTRACT

Disclosed is a molded body having heat control capability, including a core layer including a phase change material and skin layers laminated on both sides of the core layer and including a first polymer resin. Also disclosed is a method for producing the molded body, including a step of forming a core layer composition including a phase change material, a step of forming a skin layer composition including a first polymer resin, and a step of co-injecting the core layer composition and the skin layer composition to form the molded body. According to the molded body, a phenomenon in which the temperature of the molded body easily rises may be controlled by the latent heat of the phase change material without adding a microencapsulation process, and the indoor ambient temperature may also be efficiently controlled by controlling the heat absorption and reflection performance of the molded body

### BACKGROUND

### 1. Technical Field

The present disclosure relates to a molded body having heat control capability and a method for producing the same, and more particularly, to a molded body with heat control capability, which has a sandwich structure composed of a core layer including a phase change material (PCM) and skin layers laminated on both surfaces of the core layer, so that a phenomenon in which the temperature of the molded body easily rises may be controlled by the latent heat of the phase change material without adding a microencapsulation process and the indoor ambient temperature may also be efficiently controlled by controlling the heat absorption and reflection performance of the molded body, and a method for producing the same.

### 2. Related Art

With the advancement of the automotive industry, as materials previously dominated by metal have been replaced by plastics, plastics have been used in various automotive applications, including the car body, exterior, interior, decoration, and engine revolution parts. Plastics offer numerous advantages, including ease of molding and processing, light weight, and cost-effectiveness. In particular, the use of plastics in the automotive industry is primarily related to fuel efficiency through weight reduction.

The automotive industry has long been pursuing lightweight vehicle design to reduce environmental impact and improve operational performance through improved fuel efficiency. As air pollution has become more serious recently, fuel efficiency regulations have been gradually strengthened around the world to reduce exhaust gases, and thus improving fuel efficiency through weight reduction is a very important challenge.

Although power sources have been switched from gasoline engines to hybrid and electric vehicles (EVs) to improve fuel efficiency, eco-friendly vehicle components such as batteries are heavy, which increases the weight of eco-friendly vehicles compared to existing internal combustion engine vehicles. Since energy efficiency decreases as the weight increases, the application of vehicle weight reduction technology is emerging as a very important challenge in the future automobile market. In addition, various consumer demands for safety and convenience are also causing an increase in vehicle weight, and accordingly, the automotive industry is in dire need of weight reduction for existing parts, and it is expected that differences in product performance due to weight reduction technology will emerge as a major factor in determining competitiveness in the future.

The current use of plastics is about 20% of the total weight of an automobile, and it is expected that the use of plastics will increase in the future with the development of engineering plastics, plastic alloys, composite materials, and the like. As a new material in the automotive industry, plastics have limitless development prospects and possibilities, and will contribute greatly to reducing vehicle weight, increasing fuel efficiency, improving safety and ride comfort, reducing exhaust gas, lowering prices, improving performance, increasing productivity, and improving style.

However, since plastic materials have high emissivity properties, the temperature of interior materials composed of the plastic materials easily rises when heat is applied to the vehicle interior. In particular, the temperature inside a closed vehicle during the day can rise to 2 to 3 times the outside temperature, which can cause safety issues such as the risk of explosion of internal flammable materials or the risk of skin burns for children and infants, and can also cause problems such as increased energy consumption required to maintain an appropriate temperature inside the vehicle.

Accordingly, various developments have been made on technologies that can control the temperature of automotive interior materials made of plastic.

Meanwhile, phase change materials (PCMs) are materials that can store or release a large amount of heat energy, i.e., latent heat, without causing a change in temperature during their phase change from solid to liquid, from liquid to gas, or vice versa at the phase change temperature, and much research and development have been conducted on their application as heat control materials.

However, when such a phase change material is applied as it is to an automotive interior material, there is a problem that it is difficult to apply the phase change material as an automotive interior material because the phase change material is exposed on the surface of an injection-molded resin when it is incorporated into the injection-molded resin and undergoes a phase change from a solid to a liquid state at the melting point or higher.

To prevent this problem, the phase change material must be encapsulated within micro-sized capsules through a microencapsulation process. However, the microencapsulation process is expensive and increases the cost, and thus the phase change material is difficult to apply in practice as an automotive interior material.

Patent Document 1 relates to an automotive seat and interior material using a phase change material, and a method for manufacturing the same. It discloses mixing and molding a phase change material, an aqueous polyurethane resin, an aroma, an antibacterial agent, and a deodorant, thereby preparing a coating solution or an impregnation solution, and processing a fabric by coating or impregnation with the prepared coating solution or impregnation solution to use the fabric as an automobile seat or interior material.

Patent Document 2 relates to a composite particle of a phase change material and a conductive filler for a heat control material and a method for producing the same, and discloses producing a nano-composite particle by coating a phase change material as a core with a conductive filler as a shell.

However, Patent Document 1 still has the problem that the phase change material is exposed on the surface when undergoing a phase change to a liquid state at the melting point or higher and difficult to handle. In addition, Patent Document 2 is a technology that is applied to battery heat dissipation systems, etc., and when the phase change material is incorporated into a plastic injection-molded resin, there may be problems in terms of compatibility and dispersibility with the resin, and the phase change material may reduce the moldability and overall product properties.

Accordingly, in the automotive industry, there is still a need for the development of a technology that can overcome the problems caused by the small particle size of conventional powder-type thermally expandable microcapsules while satisfying both aspects of weight reduction and ensuring physical properties.

The foregoing is intended for technical information possessed for derivation of the present disclosure or acquired in the process of derivation thereof by the inventor, which is not necessarily a known technique disclosed to the general public prior to the filing of the invention.

### PRIOR ART DOCUMENTS

### Patent Documents

(Patent Document 1) Korean Patent Application Publication No. 10-2015-0081953 (published on July 15, 2015)

(Patent Document 2) Korean Patent Application Publication No. 10-2013-0067128 (published on June 21, 2013)

### SUMMARY

The present disclosure has been made in order to solve the above-described problems, and an object of the present disclosure is to provide a molded body which has a sandwich structure composed of a core layer including a phase change material and skin layers laminated on both sides of the core layer, so that a phenomenon in which the temperature of the molded body easily rises may be controlled by the latent heat of the phase change material and the indoor ambient temperature may also be efficiently controlled by controlling the heat absorption and reflection performance of the molded body.

Another object of the present disclosure is to provide a method for producing a molded body, which has heat control capability that enables efficient temperature control, in an easy manner through a co-injection process without the need to perform an additional microencapsulation process that complicates the process and increases the cost.

The present disclosure is not limited to the above-mentioned objects, and other objects of the present disclosure will be clearly understood by those skilled in the art to which the present disclosure pertains from the following description.

A molded body having heat control capability according to an embodiment of the present disclosure includes a core layer including a phase change material and skin layers laminated on both sides of the core layer and including a first polymer resin.

Here, the phase change material may include a paraffinic hydrocarbon.

Specifically, the phase change material may include N-eicosane, N-octadecane, N-heptadecane, or a combination of two or more thereof.

In addition, the phase change material may be included in an amount ranging from 15 to 25 wt % based on the total weight of the core layer.

In this case, the core layer may further include a second polymer resin, a first filler, and a second filler.

Here, the second polymer resin may include polypropylene (PP), an acrylonitrile butadiene styrene (ABS) copolymer, polyamide 6 (PA6), polycarbonate (PC), or a combination of two or more thereof.

Meanwhile, the first filler may include talc, calcium carbonate (CaCO₃), or a combination thereof.

In addition, the second filler may include silica, zeolite, or a combination thereof.

In this case, the core layer may include, based on the total weight of the core layer, 55 to 70 wt % of the second polymer resin, 10 to 15 wt % of the first filler, and 4 to 5 wt % of the second filler.

At this time, the core layer may further include an additive selected from among an antioxidant, a pigment, a lubricant, a nucleating agent, a UV stabilizer, or a combination of two or more thereof.

The additive may be included in an amount ranging from more than 0 wt % to 1 wt % or less based on the total weight of the core layer.

Meanwhile, the first polymer resin may include polypropylene (PP), an acrylonitrile butadiene styrene (ABS) copolymer, polyamide 6 (PA6), polycarbonate (PC), or a combination of two or more thereof.

At this time, the first polymer resin and the second polymer resin may include the same material.

In addition, the first polymer resin may be included in an amount ranging from 87 to 97 wt % based on the total weight of the skin layer.

In this case, the skin layer may further include a heat-reflecting filler and a heat-absorbing filler.

The heat-reflecting filler may include aluminum oxide (Al₂O₃), spherical aluminum, titanium oxide (TiO₂), zinc oxide (ZnO), or a combination of two or more thereof, and the heat-absorbing filler may include a carbon-based filler.

Specifically, the heat absorbing filler may include carbon nanotubes (CNTs), graphite, graphene, carbon black, or a combination of two or more thereof.

In this case, the skin layer may include, based on the total weight of the skin layer, 1 to 10 wt % of the heat-reflecting filler and 1 to 5 wt % of the heat-absorbing filler.

A method for producing a molded body having heat control capability according to an embodiment of the present disclosure includes: a core layer composition forming step of forming a core layer composition including a phase change material; a skin layer composition forming step of forming a skin layer composition including a first polymer resin; and a co-injection step of co-injecting the core layer composition and the skin layer composition to form the molded body.

Here, the core layer composition forming step may include a step of mixing the phase change material, a second polymer resin, a first filler, and a second filler.

In addition, the core layer composition forming step may include a first step of introducing the second polymer resin in a solid form, a second step of introducing the first filler and the second filler in a solid form after the first step, and a step of introducing the phase change material in a liquid form after the second step.

In addition, in the core layer composition forming step, the second polymer resin, the first filler, and the second filler may be introduced directly into the hopper of an extruder in a solid form, and the phase change material may be introduced in a liquid form through a liquid feeder.

At this time, the core layer composition forming step may be performed by compounding extrusion at a temperature in the range of 120 to 180° C.

In addition, the core layer composition forming step may include a step of mixing the phase change material in an amount ranging from 15 to 25 wt % based on the total weight of the core layer composition.

In this case, the phase change material may include a paraffinic hydrocarbon.

Specifically, the phase change material may include N-eicosane, N-octadecane, N-heptadecane, or a combination of two or more thereof.

At this time, the second polymer resin may include polypropylene (PP), an acrylonitrile butadiene styrene (ABS) copolymer, polyamide 6 (PA6), polycarbonate (PC), or a combination of two or more thereof.

Meanwhile, the first filler may include talc, calcium carbonate (CaCO₃), or a combination thereof.

In addition, the second filler may include silica, zeolite, or a combination thereof.

In this case, the core layer composition forming step may include a step of mixing, based on the total weight of the core layer composition, 55 to 70 wt % of the second polymer resin, 10 to 15 wt % of the first filler, and 4 to 5 wt % of the second filler.

In addition, the core layer composition forming step may further include a step of mixing an additive selected from among an antioxidant, a pigment, a lubricant, a nucleating agent, a UV stabilizer, or a combination of two or more thereof.

At this time, the core layer composition forming step may include a step of mixing the additive in an amount ranging from more than 0 wt % to 1 wt % or less based on the total weight of the core layer composition.

Meanwhile, the first polymer resin may include polypropylene (PP), an acrylonitrile butadiene styrene (ABS) copolymer, polyamide 6 (PA6), polycarbonate (PC), or a combination of two or more thereof.

At this time, the first polymer resin and the second polymer resin may include the same material.

In addition, the skin layer composition forming step may include a step of mixing the first polymer resin in an amount ranging from 87 to 97 wt % based on the total weight of the skin layer composition.

In addition, the skin layer composition forming step may further include a step of mixing a heat-reflecting filler and a heat-absorbing filler.

At this time, the heat-reflecting filler may include aluminum oxide (Al₂O₃), spherical aluminum, titanium oxide (TiO₂), zinc oxide (ZnO), or a combination of two or more thereof, and the heat-absorbing filler may include a carbon-based filler.

Specifically, the heat-absorbing filler may include carbon nanotubes (CNTs), graphite, graphene, carbon black, or a combination of two or more thereof.

In addition, the skin layer composition forming step may include a step of mixing, based on the total weight of the skin layer composition, 1 to 10 wt % of the heat-reflecting filler and 1 to 5 wt % of the heat-absorbing filler.

Meanwhile, the co-injection step may include a first injection step of injecting the skin layer composition and a second injection step of injecting the core layer composition.

At this time, the first injection step may be performed at a temperature in the range of 200 to 240° C., and the second injection step may be performed at a temperature in the range of 160 to 180° C.

As described above, the molded body having heat control capability according to an embodiment of the present disclosure has a sandwich structure composed of a core layer including a phase change material and skin layers laminated on both sides of the core layer, and thus may exhibit a desired heat transfer efficiency by the heat-reflecting filler and heat-absorbing filler included in the skin layer together with a temperature control effect by heat storage in the phase change material included in the core layer.

In addition, according to the molded body having heat control capability according to an embodiment of the present disclosure, a phenomenon in which the temperature of the molded body easily rises may be controlled through the latent heat of the phase change material, and further, the indoor ambient temperature may be controlled without using electricity.

In addition, when the molded body having heat control capability according to an embodiment of the present disclosure is applied as an automotive interior material, a phenomenon in which the temperature inside the automobile rises due to convection heat as well as radiant heat may be controlled by controlling the heat absorption and reflection performance of the interior material, so that the efficiency of automotive air conditioners and heaters may be increased, and the thermal efficiency of electric vehicles may be increased, thereby increasing the mileage.

In addition, according to the method for producing a molded body having heat control capability according to an embodiment of the present disclosure, it is possible to easily produce a molded body, which has heat control capability that enables efficient temperature control, through a co-injection process without the need to perform an additional microencapsulation process that complicates the process and increases the cost.

The present disclosure is not limited to the above-mentioned effects, and other effects of the present disclosure will be clearly understood by those skilled in the art to which the present disclosure pertains from the following description.

### BRIEF DESCRIPTION OF THE DRAWINGS

FIG. 1 is a schematic view showing a molded body having heat control capability according to an embodiment of the present disclosure.

FIG. 2 is a flowchart showing a method for producing a molded body having heat control capability according to an embodiment of the present disclosure.

FIG. 3 is a schematic diagram showing an extruder that is used in a step of forming a core layer composition in a method for producing a molded body having heat control capability according to an embodiment of the present disclosure.

FIG. 4(a)˜(c) are a schematic view showing a co-injection process that is used in a method for producing a molded body having heat control capability according to an embodiment of the present disclosure.

FIG. 5 is a graph showing the change in temperature of a molded body with a change in external temperature.

### DETAILED DESCRIPTION

The accompanying drawings in the present disclosure may have been exaggerated for differentiation and clarity from the prior art and for the sake of understanding the technology. In addition, the terms used in the specification are terms defined in consideration of functions of the present disclosure, and these terms may change depending on the intention or practice of a user or an operator. Therefore, these terms should be defined based on the overall disclosures set forth herein. Meanwhile, the following embodiments are merely for the purpose of describing the components set forth in the appended claims and are not intended to limit the spirit and scope of the disclosure.

Throughout the specification, it will be understood that, when a component is referred to as “comprising” or “including” any component, it does not exclude other components, but can further comprise or include the other components unless otherwise specified.

In addition, it will be understood that, when a component is referred to as being “connected”, “joined”, or “coupled” to another component, it can be “directly connected”, “directly joined”, or “directly coupled” to the other component or it can be “indirectly connected”, “indirectly joined”, or “indirectly coupled” to the other component with other components being interposed therebetween. On the other hand, it will be understood that, when a component is referred to as being “directly connected”, “directly joined”, or “directly coupled” to another component, no intervening components are present.

In addition, when directional terms such as “before”, “after”, “up”, “down”, “left”, “right”, “one end”, “other end”, and both ends” are used, these terms should not be construed as limiting as they are used by way of example in relation to the orientation in the drawings disclosed herein. As used herein, the terms such as “first” and “second” should not be construed as limiting terms for distinguishing each component.

In order to more clearly describe features of embodiments of the present disclosure, a detailed description of matters widely known to those skilled in the art to which the following embodiments pertain will be omitted. In addition, a detailed description of parts irrelevant to the embodiment and description in the drawings will be omitted.

Hereinafter, exemplary embodiments of the present disclosure will be described in detail with reference to the accompanying drawings.

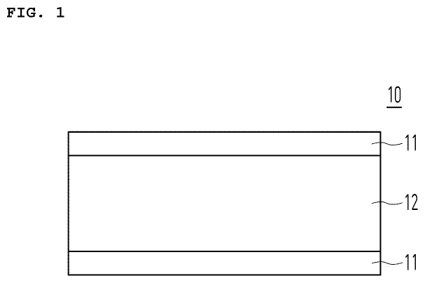

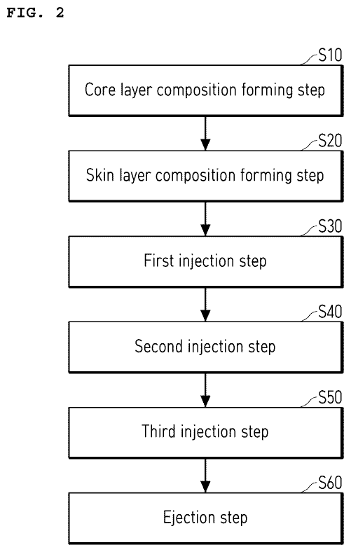

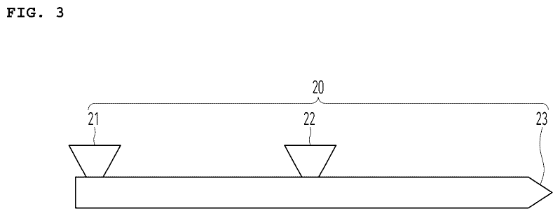

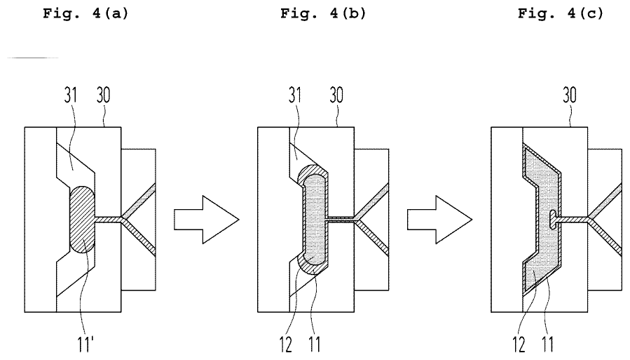

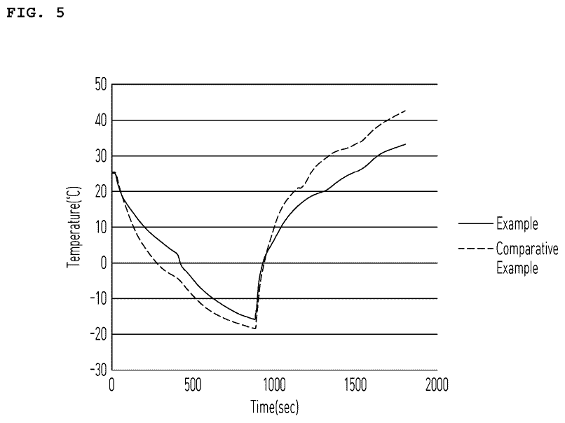

FIG. 1 is a schematic view showing a molded body having heat control capability according to an embodiment of the present disclosure, FIG. 2 is a flowchart showing a method for producing a molded body having heat control capability according to an embodiment of the present disclosure, FIG. 3 is a schematic diagram showing an extruder that is used in a step of forming a core layer composition in a method for producing a molded body having heat control capability according to an embodiment of the present disclosure, FIG. 4 is a schematic view showing a co-injection process that is used in a method for producing a molded body having heat control capability according to an embodiment of the present disclosure, and FIG. 5 is a graph showing the change in temperature of a molded body with a change in external temperature.

Referring to FIG. 1, a molded body 10 having heat control capability according to an embodiment of the present disclosure includes a core layer 12 and skin layers 11.

The core layer 12 may function to enable the molded body 10 to exhibit heat control capability.

For this purpose, the core layer 12 includes a phase change material.

The phase change materials is a material that may store or release a large amount of heat energy, i.e., latent heat, without causing a change in temperature during its phase change from solid to liquid, from liquid to gas, or vice versa at the phase change temperature.

In this embodiment, the phase change material included in the core layer 12 may control the temperature of the molded body 10 from easily rising by storing heat when heat is applied to a space where the molded body 10 is applied, for example, a vehicle interior.

In addition, in this embodiment, the phase change material may be included in the core layer 12 in the form of a raw material without being encapsulated.

In one embodiment, the phase change material may include a paraffinic hydrocarbon.

In one embodiment, the phase change material may include N-eicosane, N-octadecane, N-heptadecane, or a combination of two or more thereof, and preferably may include N-eicosane.

Since the phase change materials have different melting points, they may be appropriately selected by taking the melting point into consideration.

For example, the melting point of N-eicosane is 38° C., the melting point of N-octadecane is 28° C., and the melting point of N-heptadecane is 22° C. In one embodiment, N-eicosane having a melting point similar to body temperature may be selected as the phase change material.

The phase change material may be included in an amount ranging from 15 to 25 wt % based on the total weight of the core layer 12. If the content of the phase change material is lower than the lower limit of the above range, the heat storage property will be insufficient and the heat control ability may not be properly exhibited, and if the content is higher than the upper limit of the above range, the dispersibility may be reduced during compounding extrusion in the process of forming the core layer, which may cause a backflow or bridging phenomenon in the hopper of the extruder.

The core layer 12 may further include a second polymer resin, a first filler, and a second filler.

The second polymer resin may be a base resin that serves as a base for the core layer 12.

The second polymer resin may be appropriately selected depending on the required properties of a part to which the molded body 10 having heat control capability is applied, for example, the required properties of an automotive interior part.

In one embodiment, the second polymer resin may include polypropylene (PP), an acrylonitrile butadiene styrene (ABS) copolymer, polyamide 6 (PA6), polycarbonate (PC), or a combination of two or more thereof.

The second polymer resin may be included in an amount ranging from 55 to 70 wt % based on the total weight of the core layer 12. If the content of the second polymer resin is lower than the lower limit of the above range, it may be difficult to meet the required properties of a part to which the molded body is applied, and if the content is higher than the upper limit of the above range, the content of the phase change material may be insufficient, so that the heat control capability may not be properly exhibited, or the content of the first filler and the second filler may be insufficient, so that the phase change material may be difficult to impregnate, which may cause problems in forming the composition.

The first filler may serve to enhance the properties of the core layer 12 and effectively impregnate the phase change material.

In one embodiment, the first filler may include talc, calcium carbonate (CaCO₃), or a combination thereof.

The first filler may be included in an amount ranging from 10 to 15 wt % based on the total weight of the core layer 12. If the content of the first filler is lower than the lower limit of the above range, it may be difficult to properly exhibit the effect of enhancing properties and impregnating the phase change material, and if the content is higher than the upper limit of the above range, problems with dispersibility may occur and deterioration of properties may occur.

The second filler may serve to effectively impregnate the phase change material.

In one embodiment, the second filler may include silica, zeolite, or a combination thereof.

The second filler may be included in an amount ranging from 4 to 5 wt % based on the total weight of the core layer 12. If the content of the second filler is lower than the lower limit of the above range, it may be difficult to properly exhibit the effect of impregnating the phase change material, and if the content is higher than the upper limit of the above range, problems with dispersibility may occur and deterioration of properties may occur.

The core layer 12 may further include an additive to improve the properties and prevent thermal decomposition of the phase change material.

The above additives may be selected from among an antioxidant, a pigment, a lubricant, a nucleating agent, a UV stabilizer, or a combination of two or more thereof.

The antioxidant may serve to prevent thermal decomposition of the phase change material, and may include, for example, dibutylhydroxytoluene (BHT).

The additive may be included in an amount ranging from more than 0 wt % to 1 wt % or less based on the total weight of the core layer 12.

The skin layers 11 may serve to prevent the phase change material included in the core layer 12 from changing into a liquid at the melting point and leaking to the outside, and to compensate for the deterioration of properties caused by the phase change material. In addition, the skin layers 11 may have a heat-reflective function and a heat-absorbing function, and thus may serve to maximize the desired heat transfer efficiency.

The skin layers 11 are laminated on both sides of the core layer 12 and may include a first polymer resin.

In this embodiment, even if the phase change material included in the core layer 12 is used in its raw material form without being encapsulated, the problem that the unencapsulated phase change material leaks to the outside may be solved by laminating the skin layers 11 on both sides of the core layer 12.

The first polymer resin may be a base resin that serves as a base for the skin layers 11.

The first polymer resin may be appropriately selected depending on the required properties of a part to which the molded body 10 having heat control capability is applied, for example, the required properties of an automotive interior part.

The first polymer resin may include polypropylene (PP), an acrylonitrile butadiene styrene (ABS) copolymer, polyamide 6 (PA6), polycarbonate (PC), or a combination of two or more thereof.

The first polymer resin may be included in an amount ranging from 87 to 97 wt % based on the total weight of the skin layer 11. If the content of the first polymer resin is lower than the lower limit of the above range, it may be difficult to meet the required properties of a part to which the molded body is applied, and the effect of compensating for properties may be insufficient, and if the content is higher than the upper limit of the above range, it may be difficult to properly exhibit the heat-reflective function and heat-absorbing function of the skin layers 11.

In one embodiment, the first polymer resin and the second polymer resin may include the same material.

The skin layer 11 may further include a heat-reflecting filler and a heat-absorbing filler.

The heat-reflecting filler and the heat-absorbing filler may serve to maximize the desired heat transfer efficiency by allowing the skin layers 11 to exhibit a heat-reflective function and a heat-absorbing function.

The heat-reflecting filler may include aluminum oxide (Al₂O₃), spherical aluminum, titanium oxide (TiO₂), zinc oxide (ZnO), or a combination of two or more thereof.

The heat-reflecting filler may be included in an amount ranging from 1 to 10 wt % based on the total weight of the skin layer 11. If the content of the heat-reflecting filler is lower than the lower limit of the above range, the heat-reflecting effect may be insufficient, and thus the desired heat transfer efficiency may not be obtained, and if the content is higher than the upper limit of the above range, dispersibility and properties may be deteriorated.

The heat-absorbing filler may include a carbon-based filler, and may include carbon nanotubes (CNTs), graphite, graphene, carbon black, or a combination of two or more thereof.

The heat-absorbing filler may be included in an amount ranging from 1 to 5 wt % based on the total weight of the skin layer. If the content of the heat absorbing filler is lower than the lower limit of the above range, the heat absorbing effect may be insufficient, and thus the desired heat transfer efficiency may not be obtained. If the content is higher than the upper limit of the above range, dispersibility and properties may be deteriorated.

The molded body 10 having heat control capability according to an embodiment of the present disclosure has a sandwich structure composed of the core layer 12 including a phase change material and the skin layers 11, and thus may exhibit a desired heat transfer efficiency by the heat-reflecting filler and heat-absorbing filler included in the skin layers 11 together with a temperature control effect by heat storage in the phase change material included in the core layer 12. In addition, according to the molded body, a phenomenon in which the temperature of the molded body easily rises may be controlled through the latent heat of the phase change material without encapsulating the phase control material, and furthermore, the indoor ambient temperature may also be controlled without using electricity. Furthermore, when the molded body 10 having heat control capability according to an embodiment of the present disclosure is applied as an automotive interior material, a phenomenon in which the temperature inside the automobile rises due to convection heat as well as radiant heat may be controlled by controlling the heat absorption and reflection performance of the interior material, so that the efficiency of automotive air conditioners and heaters may be increased, and the thermal efficiency of electric vehicles may be increased, thereby increasing the mileage.

Hereinafter, a method for producing a molded body having heat control capability according to an embodiment of the present disclosure will be described with reference to FIGS. 1 to 4. The method for producing a molded body having heat control capability as shown in FIGS. 2 to 4 is a method for producing a molded body having heat control capability according to the aforementioned embodiment shown in FIG. 1. Accordingly, in this embodiment, detailed description of the contents described in relation to the embodiment shown in FIG. 1 will be omitted in order to avoid repetition.

The method for producing a molded body having heat control capability according to an embodiment of the present disclosure may include a core layer composition forming step (S10), a skin layer composition forming step (S20), and a co-injection step. In addition, the method for manufacturing a molded body having heat control capability according to an embodiment of the present disclosure may further include an ejection step (S60).

The core layer composition forming step (S10) is a step of forming a core layer composition including a phase change material.

In the core layer composition forming step (S10), the phase change material may be mixed in an amount ranging from 15 to 25 wt % based on the total weight of the core layer composition.

The core layer composition forming step (S10) may further include a step of mixing the phase change material, the second polymer resin, the first filler, and the second filler.

In the core layer composition forming step (S10), based on the total weight of the core layer composition, 55 to 70 wt % of the second polymer resin, 10 to 15 wt % of the first filler, and 4 to 5 wt % of the second filler may be mixed together.

The step core layer composition forming step (S10) may be performed by compounding extrusion at a temperature in the range of 120 to 180° C.

The core layer composition forming step (S10) should be performed by compounding at a low temperature so that thermal decomposition does not occur, taking into account the thermal decomposition temperature of the phase change material (e.g., 220 to 240° C. for N-eicosane).

For example, the core layer composition forming step (S10) may be performed through an extruder 20 shown in FIG. 3, and at this time, the temperature on the hopper 21 side may be 120° C., and the temperature on the extruder head 23 side may be 180° C. or less.

In the core layer composition forming step (S10), if the temperature on the hopper 21 side is excessively high, or the content of the phase change material is excessively high, or the phase change material is not properly impregnated by the first filler and the second filler, or the melting index (MI) of the core layer 12 is excessively high, a backflow or bridging phenomenon may occur in the hopper 21.

The core layer composition forming step (S10) may include a first step of introducing the second polymer resin in a solid form, a second step of introducing the first filler and the second filler in a solid form after the first step, and a step of introducing the phase change material in a liquid form after the second step.

That is, in the core layer composition forming step (S10), the introduction of each component may be performed in the following order: the second polymer resin, the first filler, the second filler, and the phase change material. The second polymer resin, the first filler, and the second filler may be introduced in a solid form, and the phase change material may be introduced in a liquid form. By introducing each component in the above order in the core layer composition forming step (S10), it is possible to achieve uniform dispersion of each component and effective impregnation of the phase change material.

In the core layer composition forming step (S10), the second polymer resin, the first filler, and the second filler may be introduced directly into the hopper 21 of the extruder 20 in a solid form, and the phase change material may be introduced in a liquid form through a liquid feeder 22. By separately introducing the solid and liquid components in the core layer composition forming step (S10), it is possible to achieve uniform dispersion of each component and effective impregnation of the phase change material.

The step of forming the core layer composition may further include a step of mixing an additive selected from among an antioxidant, a pigment, a lubricant, a nucleating agent, a UV stabilizer, or a combination of two or more thereof.

The core layer composition forming step may further include a step of mixing the additive in an amount ranging from more than 0 wt% to 1 wt % or less based on the total weight of the core layer composition.

The skin layer composition forming step (S20) is a step of forming a skin layer composition including a first polymer resin.

The skin layer composition forming step (S20) may be performed by compounding extrusion.

The skin layer composition forming step (S20) may include a step of mixing the first polymer resin in an amount ranging from 87 to 97 wt % based on the total weight of the skin layer composition.

The skin layer composition forming step (S20) may further include a step of mixing a heat-reflecting filler and a heat-absorbing filler.

The skin layer composition forming step (S20) may further include a step of mixing, based on the total weight of the skin layer composition, mixing 1 to 10 wt % of the heat-reflecting filler and 1 to 5 wt % of the heat-absorbing filler.

The co-injection step is a step of co-injecting the core layer composition and the skin layer composition to form the molded body 10.

The co-injection process is a method of sequentially molding two or more types of materials or materials of different colors in a single mold using two or more injection devices, or simultaneously injecting two types of resins using two injection devices to make layers. In this embodiment, the molded body 10 may be formed using a co-injection process known in the art.

The co-injection step may include a first injection step (S30) of injecting the skin layer composition and a second injection step (S40) of injecting the core layer composition. In addition, the co-injection step may further include a third injection step (S50) of re-injecting the skin layer composition and removing the core layer composition from a sprue.

Referring to FIG. 4, in the first injection step (S30), the skin layer composition may be injected into a cavity 31 of a mold 30 to form an initial skin layer 11′.

The first injection step (S30) may be performed at a temperature in the range of 200 to 240° C. If the temperature of the first injection step (S30) is lower than the lower limit of the above range, the injection of the skin layer composition may not be performed smoothly, and if the temperature is higher than the upper limit of the above range, thermal decomposition of the skin layer composition may occur.

In the second injection step (S40), the core layer composition may be injected into the cavity 31 of the mold 30 to form the core layer 12, and the initial skin layer 11′ may be converted into the skin layers 11.

The second injection step S40 may be performed at a temperature in the range of 160 to 180° C. If the temperature of the second injection step (S40) is lower than the lower limit of the above range, injection of the core layer composition may not be performed smoothly, and if the temperature is higher than the upper limit of the above range, thermal decomposition of the core layer composition may occur.

In addition, if the content of the phase change material in the core layer composition is excessively high, a flow rate reversal phenomenon may occur due to an increase in the melting index of the core layer 12 in the second injection step (S40), and thus the positions of the skin layer 11 and the core layer 12 may be reversed.

Through the first injection step (S30) and the second injection step (S40), the molded body 10 having a sandwich structure in which the skin layers 11 are laminated on both sides of the core layer 12 may be formed.

The third injection step (S50) is a step of re-injecting the skin layer composition and removing the core layer composition from the sprue, and may optionally be performed.

According to the method for producing a molded body having heat control capability according to an embodiment of the present disclosure, it is possible to easily produce a molded body, which has heat control capability that enables efficient temperature control, through a co-injection process without the need to perform an additional microencapsulation process that complicates the process and increases the cost.

Hereinafter, the present disclosure will be described in more detail through examples. However, the following examples are merely illustrative of the present disclosure, and the scope of the present disclosure is not limited to the following examples.

### EXAMPLES

### 1. Production of Molded Body Having Heat Control Capability

A core layer composition was formed by sequentially introducing 65 wt % of polypropylene resin, 10 wt % of talc, 4 wt % of silica, and 1 wt % of butylhydroxytoluene (BHT) into the hopper 21 of the extruder 20 shown in FIG. 3, introducing 20 wt % of N-eicosane into the liquid feeder 22, and setting the temperature of the hopper 21 to 120° C. and the temperature of the head 23 of the extruder 20 to 180° C. or lower, followed by compounding extrusion.

A skin layer composition was formed by introducing 95 wt % of polypropylene resin, 3 wt % of Al₂O₃, and 2 wt % of CNTs into the hopper 21 of the extruder 20, followed by compounding extrusion.

The skin layer composition was injected at a temperature of 220° C. using a co-injection device, and then the core layer composition was injected at a temperature of 180° C., thereby producing a molded body having heat control capability according to the Example of the present disclosure, which has a sandwich structure having a core layer and skin layers laminated on both sides of the core layer.

### 2. Characterization of Molded Body Having Heat Control Capability

For the molded body having heat control capability according to the Example of the present disclosure and a molded body made solely of polypropylene resin (Comparative Example), the temperature characteristics according to a change in external temperature were evaluated, and the results are shown in FIG. 5.

Referring to FIG. 5, it can be confirmed that, when the external temperature changed from −30 to 50° C., the molded body having heat control capability according to the Example maintained a difference in temperature of up to 10° C. from that of the Comparative Example.

As described above, the molded body having heat control capability according to an embodiment of the present disclosure has a sandwich structure composed of a core layer including a phase change material and skin layers laminated on both sides of the core layer, and thus may exhibit a desired heat transfer efficiency by the heat-reflecting filler and heat-absorbing filler included in the skin layer together with a temperature control effect by heat storage in the phase change material included in the core layer. Accordingly, a phenomenon in which the temperature of the molded body easily rises may be controlled through the latent heat of the phase change material, and furthermore, the indoor ambient temperature may also be controlled without using electricity. In addition, according to the molded body, a phenomenon in which the temperature of the molded body easily rises may be controlled through the latent heat of the phase change material without encapsulating the phase control material, and furthermore, the indoor ambient temperature may also be controlled without using electricity. Furthermore, when the molded body having heat control capability according to an embodiment of the present disclosure is applied as an automotive interior material, a phenomenon in which the temperature inside the automobile rises due to convection heat as well as radiant heat may be controlled by controlling the heat absorption and reflection performance of the interior material, so that the efficiency of automotive air conditioners and heaters may be increased, and the thermal efficiency of electric vehicles may be increased, thereby increasing the mileage. In addition, according to the method for producing a molded body having heat control capability according to an embodiment of the present disclosure, it is possible to easily produce a molded body, which has heat control capability that enables efficient temperature control, through a co-injection process without the need to perform an additional microencapsulation process that complicates the process and increases the cost.

While the present disclosure has been described with respect to the embodiments illustrated in the drawings, it will be obvious to those skilled in the art that such embodiments are provided by way of example only. It will be understood by those skilled in the art that various modifications and other equivalent embodiments may be made without departing from the spirit and scope of the disclosure as defined in the following claims. Therefore, the true technical protection scope of the present disclosure should be defined by technical concepts of the appended claims.

What is claimed is:

1. A molded body having heat control capability, comprising:
a core layer comprising a phase change material; and
skin layers laminated on both sides of the core layer and comprising a first polymer resin.

2. The molded body of claim 1, wherein the phase change material comprises a paraffinic hydrocarbon.

3. The molded body of claim 1, wherein the phase change material is comprised in an amount ranging from 15 to 25 wt % based on the total weight of the core layer.

4. The molded body of claim 1, wherein the core layer further comprises a second polymer resin, a first filler, and a second filler.

5. The molded body of claim 4, wherein
the second polymer resin comprises polypropylene (PP), an acrylonitrile butadiene styrene (ABS) copolymer, polyamide 6 (PA6), polycarbonate (PC), or a combination of two or more thereof,
the first filler comprises talc, calcium carbonate (CaCO₃), or a combination thereof, and
the second filler comprises silica, zeolite, or a combination thereof.

6. The molded body of claim 4, wherein the core layer comprises, based on the total weight of the core layer, 55 to 70 wt % of the second polymer resin, 10 to 15 wt % of the first filler, and 4 to 5 wt % of the second filler.

7. The molded body of claim 1, wherein the first polymer resin comprises polypropylene (PP), an acrylonitrile butadiene styrene (ABS) copolymer, polyamide 6 (PA6), polycarbonate (PC), or a combination of two or more thereof.

8. The molded body of claim 1, wherein the first polymer resin is comprised in an amount ranging from 87 to 97 wt % based on the total weight of the skin layer.

9. The molded body of claim 1, wherein the skin layer further comprises a heat-reflecting filler and a heat-absorbing filler, wherein the heat-reflecting filler comprises aluminum oxide (Al₂O₃), spherical aluminum, titanium oxide (TiO₂), zinc oxide (ZnO), or a combination of two or more thereof, and the heat-absorbing filler comprises a carbon-based filler.

10. The molded body of claim 9, wherein the skin layer comprises, based on the total weight of the skin layer, 1 to 10 wt% of the heat-reflecting filler and 1 to 5 wt % of the heat-absorbing filler.

11. A method for producing a molded body having heat control capability, comprising:
a core layer composition forming step of forming a core layer composition comprising a phase change material;
a skin layer composition forming step of forming a skin layer composition comprising a first polymer resin; and
a co-injection step of co-injecting the core layer composition and the skin layer composition to form the molded body.

12. The method of claim 11, wherein the core layer composition forming step comprises a step of mixing the phase change material, a second polymer resin, a first filler, and a second filler.

13. The method of claim 11, wherein the core layer composition forming step is performed by compounding extrusion at a temperature in a range of 120 to 180° C.

14. The method of claim 11, wherein the core layer composition forming step comprises a step of mixing the phase change material in an amount ranging from 15 to 25 wt % based on the total weight of the core layer composition.

15. The method of claim 12, wherein
the second polymer resin comprises polypropylene (PP), an acrylonitrile butadiene styrene (ABS) copolymer, polyamide 6 (PA6), polycarbonate (PC), or a combination of two or more thereof,
the first filler comprises talc, calcium carbonate (CaCO₃), or a combination thereof, and
the second filler comprises silica, zeolite, or a combination thereof.

16. The method of claim 12, wherein the core layer composition forming step comprises a step of mixing, based on the total weight of the core layer composition, 55 to 70 wt % of the second polymer resin, 10 to 15 wt % of the first filler, and 4 to 5 wt % of the second filler.

17. The method of claim 11, wherein the first polymer resin comprises polypropylene (PP), an acrylonitrile butadiene styrene (ABS) copolymer, polyamide 6 (PA6), polycarbonate (PC), or a combination of two or more thereof.

18. The method of claim 11, wherein the skin layer composition forming step comprises a step of mixing the first polymer resin in an amount ranging from 87 to 97 wt % based on the total weight of the skin layer composition.

19. The method of claim 11, wherein the skin layer composition forming step further comprises a step of mixing a heat-reflecting filler and a heat-absorbing filler, wherein the heat-reflecting filler comprises aluminum oxide (Al₂O₃), spherical aluminum, titanium oxide (TiO₂), zinc oxide (ZnO), or a combination of two or more thereof, and the heat-absorbing filler comprises a carbon-based filler.

20. The method of claim 19, wherein the skin layer composition forming step comprises a step of mixing, based on the total weight of the skin layer composition, 1 to 10 wt % of the heat-reflecting filler and 1 to 5 wt % of the heat-absorbing filler.
